(19) United States
(12) Patent Application Publication
(10) Pub. No.: US 2012/0265902 A1
(43) Pub. Date: Oct. 18, 2012

(54) METHOD AND SYSTEM FOR PROVIDING PREVALIDATED SECURE PRODUCT MAINTENANCE, REPAIR AND TRAINING INFORMATION TO A FIELD TECHNICIAN

(75) Inventors: Patrick W. Cumby, Edenton, NC (US); Al Seidel, Camden, NC (US); Stanley J. Walz, Elizabeth City, NC (US)

(73) Assignee: VectorCsp, LLC

(21) Appl. No.: 13/088,477

(22) Filed: Apr. 18, 2011

(51) Int. Cl. G06F 15/16

(52) U.S. Cl. 709/248

(57) ABSTRACT

The present invention relates providing maintenance, repair, and training to a remote field technician and ability to sign off on work or training without the ability to edit or otherwise change information in a secure and updatable manner utilizing a secured handheld display device for displaying text, video, graphs, figures, and the like.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates providing maintenance, repair, and training to a remote field technician and ability to sign off on work or training without the ability to edit or otherwise change information in a secure and updatable manner utilizing a secured handheld display device for displaying text, video, graphs, figures, and the like.

2. Description of Related Art

In the life cycle of machine equipment and the like utilized by large organizations such as the military, it is necessary to develop service manual type instructions for field use in maintenance and repair, and training of individual machine equipment repair and maintenance, and provide records of the maintenance and repair of the machine equipment. The creation, validation, and updating of the information has additional costs of developing and frequently represents a substantial cost of owning machine equipment.

Maintenance, repair, and training information procedures are usually needed in large organizations, for example, in the military, consisting of text, drawings, engineering specs, CIDs, exploded views, videos, and the like for equipment that is small or large, like an airplane, aircraft carrier, or the like. In a large organization, after development of these materials, they are routinely printed out in manuals, card stock, or some other format for distribution to the machine in the field along with the technician (user), however, constant manual updates, new procedures and the need for centralization of information (including repair logs and the like), have made the paper trail a nightmare, although, avoiding computers does keep the information secure in an individual's hand. The need to have the best, most updated information means that information on paper is frequently outdated before it can even get a maintenance, repair, or training information into a technician's hand. Likewise, where frequent update and multiple models of machines or even a particular machine with unique characteristics that exist, it becomes difficult to provide updated and accurate information, not to mention the time it takes to work with a machine while it's out of service during training only to find a problem with the provided information.

### BRIEF SUMMARY OF THE INVENTION

The present invention relates to providing a secure handheld display for use in providing procedures for maintenance, repair and training of a selected asset, and in one embodiment, a military asset. By utilizing a secure computer separate from the handheld device and requiring docking with the computer to access a content library, security is maintained and updates kept consistent across an organization.

Accordingly, in one embodiment the present invention provides a system for delivering secure asset procedures to a remote handheld display device for use by a user comprising:
a) an updatable content library server;
b) an user location computer in secure communication with the content library server and comprising a display device for the remote handheld docking device and a synchronization software in resident memory on the computer for synchronizing the procedures on the server with the handheld device when docked in the docking device; and
c) a remote handheld display for displaying the procedures and docking with the docking device.

In another embodiment the present invention relates to a computer implemented method for secure delivery of asset procedures to a handheld display device for performance of the procedure by a user comprising:
a) generating updated asset procedures on a content library server;
b) docking the display device to a user location computer having a synchronization application in resident memory;
c) synchronizing the procedures on the server with the device using the synchronization application; and
d) undocking the device from the computer.

### BRIEF DESCRIPTION OF THE DRAWINGS

FIG. 1 is a block diagram of the system of the present invention.

FIG. 2 is a flow chart of an embodiment of the present invention method.

FIG. 3 is a flow chart of keeping a maintenance/repair record with the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “asset” refers to an organization's device or machine which requires mechanical repair, assembly, and maintenance procedure, as well as training procedure to do the repair, assembly, and maintenance. In a military setting it can be a boat, plane, helicopter, automobile or any other vehicle. It can also be machines like motors, generators, and the like.

As used herein the term “procedures” refers an operation that a user must perform with or on the asset. Examples of procedures on an asset include maintenance and repair of an asset. Also included are training procedures for the asset, including training for how to use and how to perform maintenance and repair of the asset. By delivering “secure” procedures the system keeps the procedures relatively safe from being changed, hacked, deleted, or the like except by authorized individuals. When the system is used in a military context it is important that a saboteur cannot easily manipulate the data in the system, and thus security of the system is critical. The procedures can be presented in written, figures, video, slide show format, or any format in color or black and white, conducive to presentation on a handheld display device. Examples of handheld display devices useful in the present invention are Trimble Yuma, HP mini, Android Viewsonic tablet, Viliv 5, Viliv 7, Archos 5, Archos 7, Archos 9 tablet, etc.

As used herein the phrase “remote handheld display device” refers to a computer or computer like device having digital storage for procedures and a digital display/GUI interface for providing the procedures to a user requiring procedures. The handheld device eliminates the reliance on wireless capabilities. It does not require wireless capability (though it may have wireless capability) and must be synchronized with another computer (docked or wirelessly) in order to update, provide comments, or the like to the total system. In use, the user can have the handheld device at the point the procedure is being implemented which is frequently at the general location, for example on board the asset, at the military base, underway, in the military pool garage, at the hangar, or at the harbor, etc. In one embodiment the remote handheld display device is also capable of collecting maintenance/management or other data about a specific asset. Details of all the assets can be kept on the user location computer, the content library, or a separate computer/server designed to track specific assets in the system. In some instances the device may need to be ruggedized or semi-ruggedized depending upon the environment.

As used herein a “user” is a person who will use the handheld device of the present invention to perform a selected procedure including on a selected asset. The user in general is a repair technician, for example, a military repair person in a vehicle repair pool or the like. The user will be at a particular location, e.g. a particular military base, on board a military asset (surface or air fleet) or a military battlefield.

As used herein the term “content library” refers to all the current asset procedures including in one embodiment procedure comments by users. The content library is created in digital format and is stored in resident memory on a server of the system. The content library is “updatable”, that is there is some form of a content editor for adding new procedures, deleting old procedures and modifying and changing current procedures so that as new knowledge is learned about the procedures (either from a user, asset manufacturer, or the like) the information in the content library is as current as possible. In one embodiment there is one or more people designed as content editors who are responsible for keeping the content library updated and who can act as a gatekeeper of information in the system. As the assets covered by the library change, the procedures can change based on the assets actually in possession and the age and condition of the assets in general or about specific assets (quirks in maintenance and repair of an individual asset). The system will not always at every moment have the most updated information and by being updatable, it can be changed to be as current as is reasonably possible as new knowledge is obtained. Updates can come from the asset manufacturer from the owner (such as comments from the military) or include comments from the user received in a secure manner. In fact, all updates should be done in a secure manner to prevent incorrect information from being included in any update. Keeping the system hardwired and not wireless is one embodiment of keeping the system of the present invention secure. Other ways the system is kept secure are for example procedures are only updateable through the content management system and not on the handheld device or the synchronization device. “Servers” as used herein are computers having resident memory and designed as a central repository of digital information, computer process, and the like located in the resident memory. Since, in one embodiment, there are multiple locations the procedures will be delivered to individual computers and having the procedures on a server and (e.g. connected to the internet or other communication network) allows for users at a variety of locations to utilize the content library.

As used herein a “user location computer” is a computer located at the location of the user. The user location computer will be in communication with the content library server. The user location computer will have a docking station for the purpose of docking a user remote handheld display with the computer. The computer will have synchronization software in its resident memory that is capable of synchronizing the procedures on the server with the handheld device docked in the docking device. The user location computer will need to be located where each user is located, for example, one at each military base.

As utilized herein a “maintenance data” computer/server relates to a computer wherein the records of the maintenance and repair of all the assets of a particular organization are stored. The data can be for a particular location with a computer for each location or a central computer for all locations within an organization. For example, where the army utilizes the maintenance data there can be a data computer for each army base or asset, or one for the whole army. Connection to the data base can be through the location computer utilizing the docking port.

In the method of the present invention there is a computer implemented method for the secure delivery of asset procedures, to a handheld display device for performance of the procedure by a user. The asset procedures are updated on the content library server as disclosed above. Once the user decides to update the information, the handheld display device is docketed with a computer at its location which has resident software to synchronize with the server. In related methods the collected data on the handheld display device is transferred to a maintenance data computer/server.

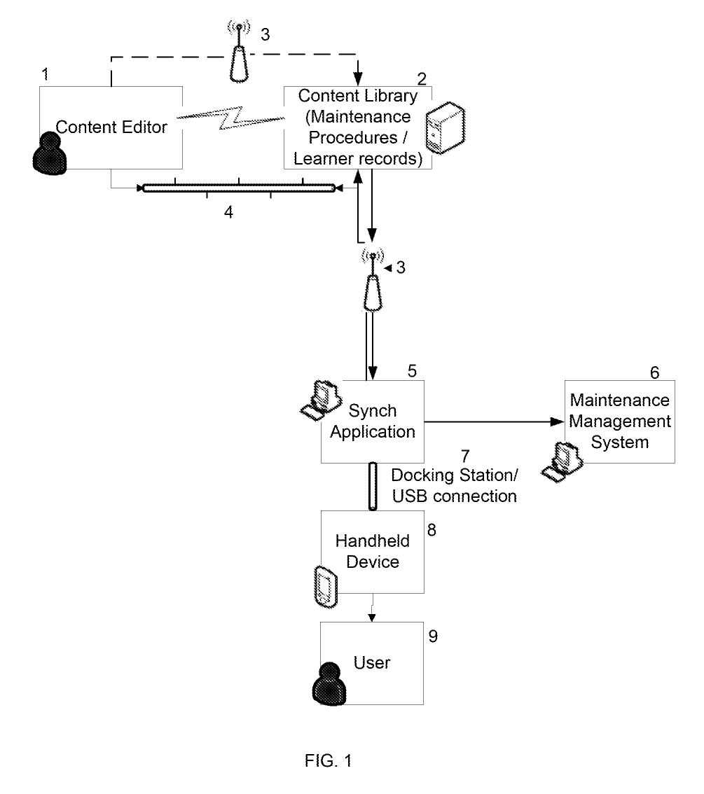

Now referring to the figures, FIG. 1 is a block diagram of the system of the present invention. In this embodiment a content editor 1 accesses the content library server 2 either by the internet or direct hardwire 4 means. This is done to update the content library 2 as disclosed above. The server 2 is in contact via the internet 3 or other communication network with the synchronization application computer 5 at the user's location. The synchronization computer 5 is in contact with the maintenance management data server 6 for updating maintenance data entered by the user. A docking station 7 is attached to the computer 5 for the purpose of being able to dock the handheld display device 8 which is utilized by a user 9.

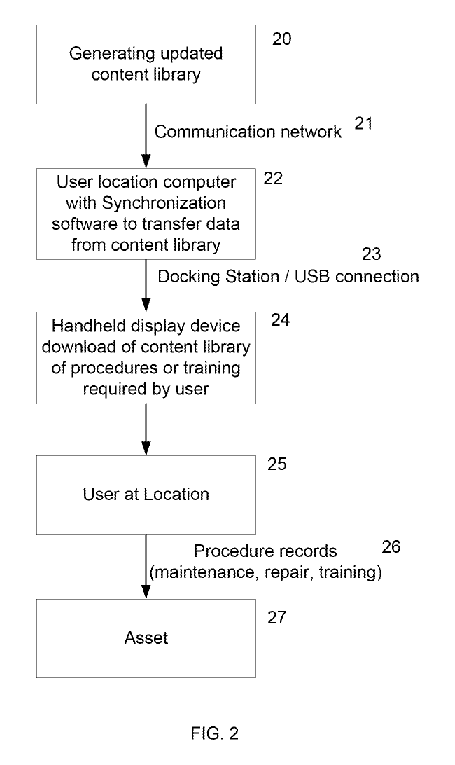

FIG. 2 is a flow chart of an embodiment of the present invention method. An updated content library 20 is prepared on a server connected to a communication network. The library is updated manually or automatically with the latest information on the procedures of the present invention. The content library is then connected via the communication network 21 to the user located computer having computer library synchronization software 22. The computer with the synchronization software is then connected via docking station or USB 23 to the handheld display device 24. The user (maintenance technician e.g.) uses the handheld device at their worksite 25 to perform procedures or take an e-learning course 26. The asset is maintained and records (maintenance or learner data) are stored on the device 27.

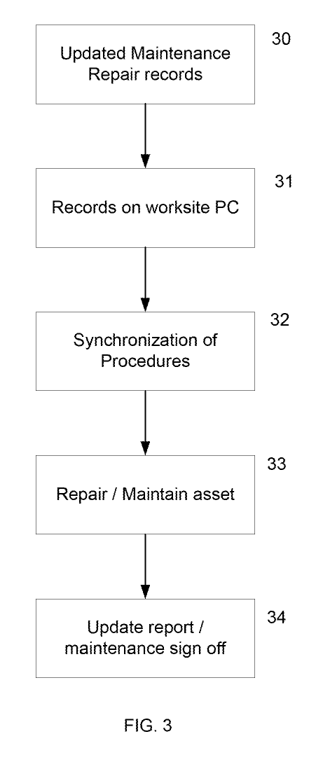

FIG. 3 is a flow chart of the present system keeping maintenance and repair records for one or more assets. In this embodiment the updated maintenance and repair records 30 for a selected asset is downloaded to the worksite PC 31. The handheld is synchronized for current procedures 32 either here or at any point in the process. Once the handheld display device has current maintenance and repair records 30 on the asset and is synced for current procedures, a user can repair or maintain a selected asset 33. A user then can complete a report 34. A “report” as used herein refers to the user sign off detailing the completed repair or maintenance on a selected asset. It can also include any data which updates the procedures or recommends new procedures for the specific asset or an asset class with the same or similar characteristics. Once the report is completed, the report 34 can then be sent back to the repair records 30 for further updating for use at a later time to again repair or maintain the asset. In other embodiments the repair records can be utilized to modify, change, or delete the procedures utilized for the asset.

As noted above, the maintenance records can be located on the local computer, can be on a separate computer/server at a separate location, or can be on the content library. The location is within one skilled in the art in view of the present disclosure and also within the need to have a global organization maintenance record or a user location record, i.e. records where the asset actually is at the moment. Local maintenance records mean more security for the whole system but do require transferring records when the asset is transferred to a new location not handled by the maintenance record computer.

The user location computer is in communication with a docking station 23 for the purpose of connecting in communication a handheld display for downloading or updating all or part of the content library 24. The handheld is designed such that it must be connected to the computer in order to access the content library. The user at a location 25 can then take the display and utilize the procedures on the display 26 in order to maintain, repair, or get training on/about an asset 27.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art, still fall within the scope of the invention as claimed by the applicant.

What is claimed is:

1. A system for delivering secure asset procedures to a remote handheld display device for use by a user comprising:
a) an updatable content library server;
b) an user location computer in secure communication with the content library server and comprising a display device for the remote handheld docking device and a synchronization software in resident memory on the computer for synchronizing the procedures on the server with the handheld device when docked in the docking device; and
c) a remote handheld display for displaying the procedures and docking with the docking device.

2. The system according to claim 1 which further comprises the display device being capable of collecting maintenance data on a select asset.

3. The system according to claim 1 which further comprises a computer for collecting maintenance data on one or more assets received from the display device.

4. The system according to claim 1 wherein a content administrator keeps the content library updated.

5. The system according to claim 1 wherein the user can give input to the content administrator for update to the content library server.

6. The system according to claim 1 wherein the procedure is selected from the group comprising maintenance, repair, and training procedures.

7. A computer implemented method for secure delivery of asset procedures to a handheld display device for performance of the procedure by a user comprising:
a) generating updated asset procedures on a content library server;
b) docking the display device to a user location computer having a synchronization application in resident memory;
c) synchronizing the procedures on the server with the device using the synchronization application; and
d) undocking the device from the computer.

8. The method according to claim 7 wherein the device collects maintenance data on an asset to which a maintenance procedure is provided.

9. The method according to claim 8 wherein the maintenance data is transferred to and stored on a maintenance data computer.

10. The method according to claim 8 wherein the maintenance data is utilized to update the content library procedures.

11. The method according to claim 7 wherein the handheld device is synchronized utilizing the internet.

12. The method according to claim 7 wherein the content library server is updated by a content administrator.

13. The method according to claim 7 wherein the user provides input of the procedures to the server via the display device.

14. The method according to claim 7 wherein the procedure is selected from the group comprising maintenance, repair and training procedures.

15. The method according to claim 7 wherein the handle display device is utilized by the user to perform a procedure on a selected asset.
